(19) United States
(12) Patent Application Publication
(10) Pub. No.: US 2016/0007801 A1
(43) Pub. Date: Jan. 14, 2016

(54) BLENDER BLADE ASSEMBLY

(71) Applicant: Manitowoc Foodservice Companies, LLC, Manitowoc, WI (US)

(72) Inventors: Gorm Bressner, Providence, RI (US); Nicholas Patterson, Odessa, FL (US); Kenneth Lundberg, Mount Pleasant, MI (US); Daryl Gregory Erbs, Sheboygan, WI (US); Janice M.K. Jaferian, Palm Harbor, FL (US)

(21) Appl. No.: 14/795,498

(22) Filed: Jul. 9, 2015

Related U.S. Application Data
(60) Provisional application No. 62/022,412, filed on Jul. 9, 2014.

(51) Int. Cl. A47J 43/07; A47J 43/08; B01F 15/00; A47J 31/44; B01F 7/00; B01F 7/22

(52) U.S. Cl. CPC A47J 43/07; B01F 7/0025; B01F 7/225; B01F 15/00538; A47J 31/4403; A47J 43/08; B01F 2215/0022

(57) ABSTRACT

A blender assembly includes a blender blade assembly. The blender blade assembly includes a rotor that is connected to a shaft. The shaft is rotatable. The blender blade assembly also includes a blade connected to said rotor, and a stator that covers said rotor. The stator that is stationary

This application claims the benefit of U.S. Provisional Application No. 62/022,412, filed Jul. 9, 2014. The contents of U.S. Provisional Application No. 62/022,412, filed Jul. 9, 2014, are hereby incorporated by reference herein in their entirety.

### BACKGROUND OF THE DISCLOSURE

1. Field of the Disclosure

The present disclosure relates generally to a blender blade assembly. More particularly, the present disclosure relates to a blender blade assembly that includes a blade, a rotor and a stator.

2. Description of Related Art

Beverages, for example, a smoothie drink, can require blending of beverage ingredients including ice, flavor ingredients, and other solid or liquid ingredients during a blending cycle. Flavor ingredients include liquid flavor ingredients, for example, fruit juice and chocolate syrup, and solid ingredients, for example, nutraceuticals, vitamins, herbs, spices, berries and other fruits, vegetables, such as spinach, celery, beets, tomatoes, cucumbers, or carrots, or pieces of fruit, vegetables or candies, such as solid chocolate pieces, apple or orange segments, or cut up vegetables. Herbs such as mint, parsley, sage, rosemary, thyme, and any other herbs. Spices such as cayenne, cinnamon, curry, nutmeg and any other spices. Many challenges are encountered during a blending cycle. Challenges are even more so when blending in a cup that is disposable, which is then served to the consumer in the same cup in which a blending cycle took place. Cups that are disposable may be deformed during the blending cycle, for example, due to the forces applied to the cup to blend the beverage ingredients during the blending cycle.

Referring to FIG. 1, a blender/mixer/cleaning module 303 is shown that is a part of an assembly that dispenses and mixes beverages as described in U.S. patent application Ser. No. 12/633,790, filed Dec. 8, 2009, the contents of which are incorporated herein by reference in its entirety. Blender/mixer/cleaning module 303 is a component of a blend-in-cup (BiC) beverage dispenser. The purpose of a blend-in-cup (BiC) beverage dispenser is to dispense raw ingredients into a disposable cup and blend the beverage to its final consistency within the disposable cup. Cup 15, for example, is made of a Styrofoam material or plastic material.

Blender/mixer/cleaning module 303 has a blender motor 265 with a shaft assembly having a spindle 260 which rotates a blade 255 that is covered by a blade guard 255a. Blender motor 265 is connected to blender bracket 267 which is fixed to a linear actuator 240 which allows vertical movement of blender motor 265 with the shaft assembly. Linear actuator 240 is connected to a support structure 237. Support structure 237 supports an interior volume 230 of blender/mixer/cleaning module 303 to hold cup 15 in place during a blending cycle in which blade 255 and blade guard 255a are positioned inside cup 15 to blend beverage ingredients, for example, ice and flavor ingredients, to form a beverage in cup 15.

Traditionally, in order to process a working medium that includes ice and beverage ingredients to a desired set of characteristics, a blending cycle could last between 20-40 seconds. This cycle time may be an operational burden for certain applications, typically in high use environments.

Accordingly, it has been determined by the present disclosure, there is a need for a blender blade assembly that blends ice and beverage ingredients quicker and more effectively.

### SUMMARY

A blender assembly includes a blender blade assembly. The blender blade assembly includes a rotor that is connected to a shaft. The shaft is rotatable. The blender blade assembly also includes a blade connected to said rotor, and a stator that covers said rotor. The stator that is stationary

The above-described and other advantages and features of the present disclosure will be appreciated and understood by those skilled in the art from the following detailed description, drawings, and appended claims.

### BRIEF DESCRIPTION OF THE DRAWINGS

FIG. 1 is a partial cross-sectional side view of a blender assembly having a blender blade assembly of the prior art.

FIG. 2 is an enlarged partial side view of a blender blade assembly according to the present disclosure.

FIG. 3 is a bottom view of the blender blade assembly of FIG. 2.

FIG. 4 is a side cross-sectional view of the blender blade assembly of FIG. 2.

FIG. 5 is a top side perspective view of the blender blade assembly of FIG. 2.

FIG. 6 is a top side perspective view of the blender blade assembly of FIG. 2 with a stator being shown as transparent.

FIG. 7 is a top side perspective view of the blender blade assembly of FIG. 2 with the stator removed.

FIG. 8 is a bottom side perspective view of the blender blade assembly of FIG. 2.

### DETAILED DESCRIPTION OF THE DISCLOSURE

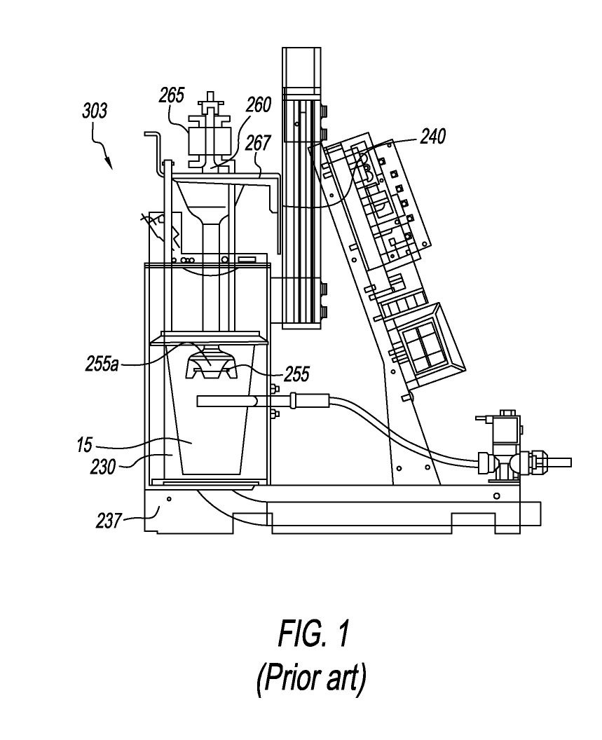

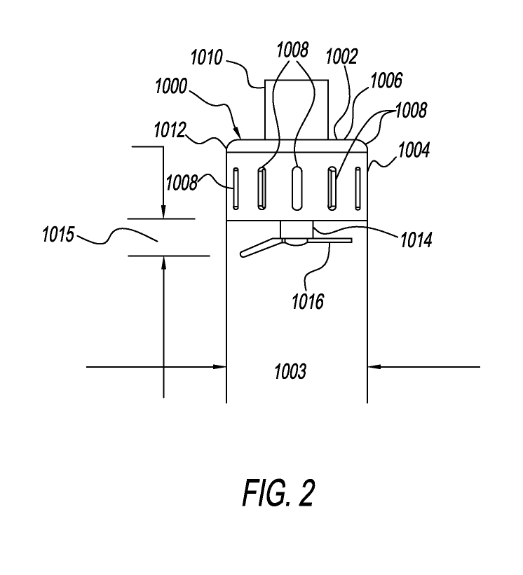

Referring to the drawings and in particular to FIG. 2, an exemplary embodiment a blender blade assembly of the present disclosure is generally referred to by 1000. Blender blade assembly 1000 may be incorporated into a blender, for example, blender/mixer/cleaning module 303 of FIG. 1 that is a part of an assembly that dispenses and mixes beverages as described in U.S. patent application Ser. No. 12/633,790, filed Dec. 8, 2009, the contents of which are incorporated herein by reference in its entirety. Blender blade assembly 1000 may replace blade 255 and blade guard 255a of FIG. 1. Blender blade assembly 1000 is a bending head that can be mounted to an end of a shaft, driven by an electric motor, with rotation about a vertical axis with some portion of the entire blender configuration being encompassed by a blending housing.

Referring back to FIG. 2, blender blade assembly 1000 has a stator 1002. Stator 1002 has a side wall 1004 that extends from a central wall 1006. Stator 1002 has a width 1003, for example, of 2 inches. Stator 1002 has apertures 1008 through side wall 1004. Apertures 1008 are each a stadium shape. Stator 1002 forms a curved surface 1012 between side wall 1004 and central wall 1006. Central wall 1006 is connected to an outer shaft 1010. A connection shaft 1014 is connected to a blade 1016. Blade 1016 is positioned on connection shaft 1014 to be spaced a distance 1015 from stator 1002. Distance 1015, for example, is 0.52 inches.

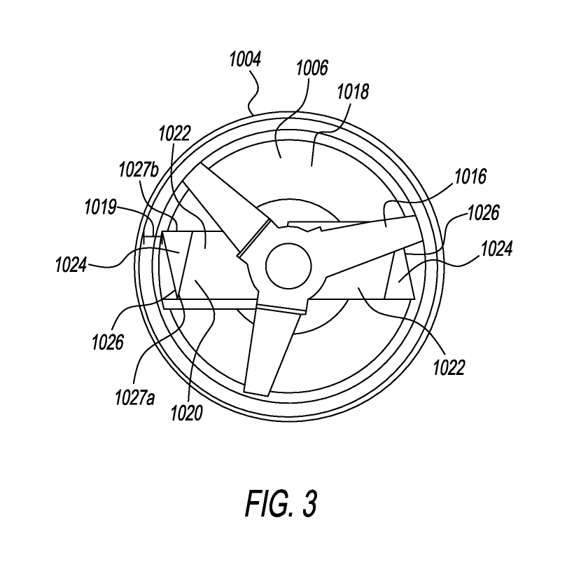

Referring to FIG. 3, side wall 1004 and central wall 1006 form an interior volume 1018. A rotor 1020 is positioned in interior volume 1018. Rotor 1020 has connectors 1022 and vanes 1024 extending from each of connectors 1022. Connectors 1020 each have a rectangular shaped cross-section. Each of vanes 1024 has a triangular shaped cross-section. Each of connectors 1022 are opposite to one another. Vanes 1024 each have triangular shaped cross-sections that have apexes 1026 facing opposite directions. Apex 1026 is at a leading edge 1027a of vane 1024 opposite a trailing edge 1027b that is flat. Rotor 1020 and side wall 1004 form a space 1019 between rotor 1020 and side wall 1004 of stator 1002.

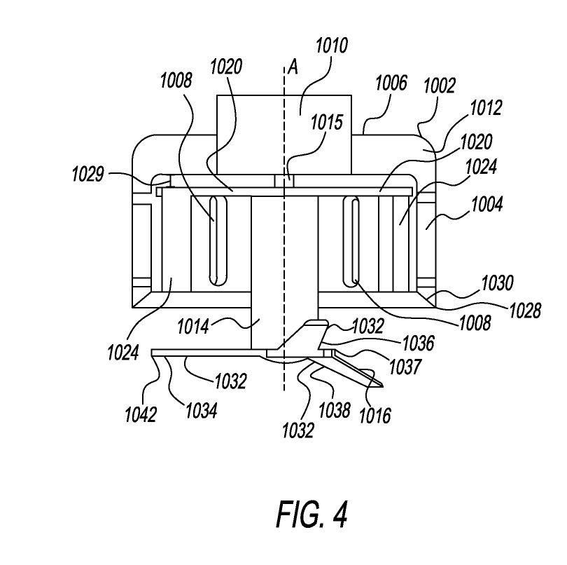

Referring to FIG. 4, rotor 1020 is connected to connection shaft 1014 connecting blade 1016 and rotor 1020. Rotor 1020 is connected to an inner shaft 1015 positioning rotor 1020 in interior volume 1018. Inner shaft 1015 is positioned in outer shaft 1010. Inner shaft 1015, for example, is spindle 260 of FIG. 1, which rotates rotor 1020, connection shaft 1014, and blade 1016. Rotor 1020 and central wall 1006 of stator 1002 form a space 1029. Side wall 1004 has a free end 1028 that is opposite an end of side wall 1004 that forms curved surface 1012. Side wall 1004 has and an edge 1030 formed by a length of said side wall that decreases in width to free end 1028.

Blade 1016 has three blade wings 1032 extending outward from connection shaft 1014. Three blade wings 1032 has a first wing 1034 extending perpendicular to an axis of rotation A of blade 1016, a second wing 1036 that extends at an upward angle from a flat center 1037 of blade 1016, and a third wing 1038 that extends at a downward angle from flat center 1037.

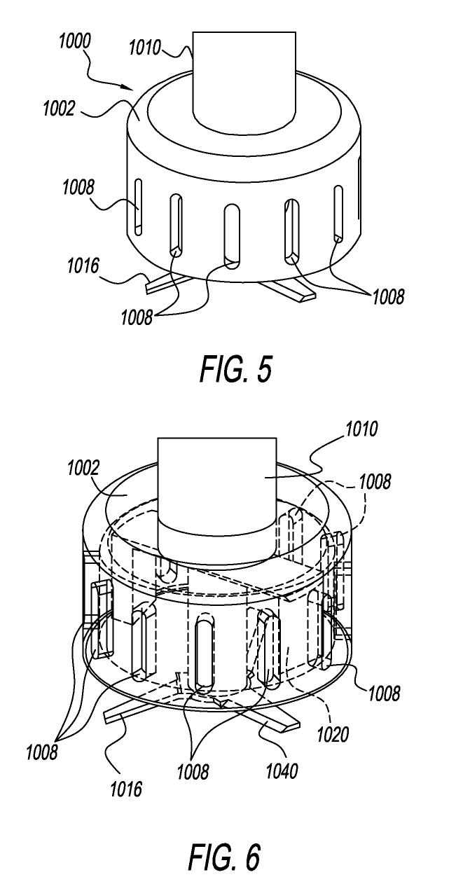

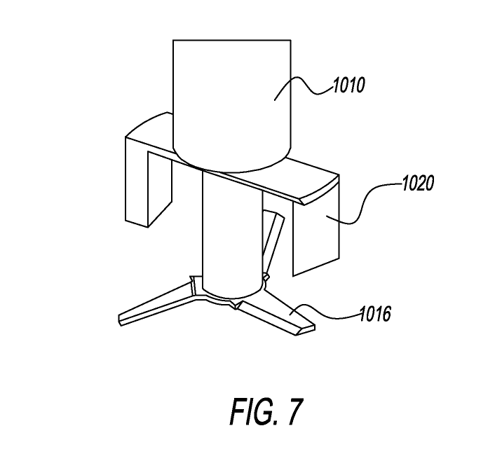

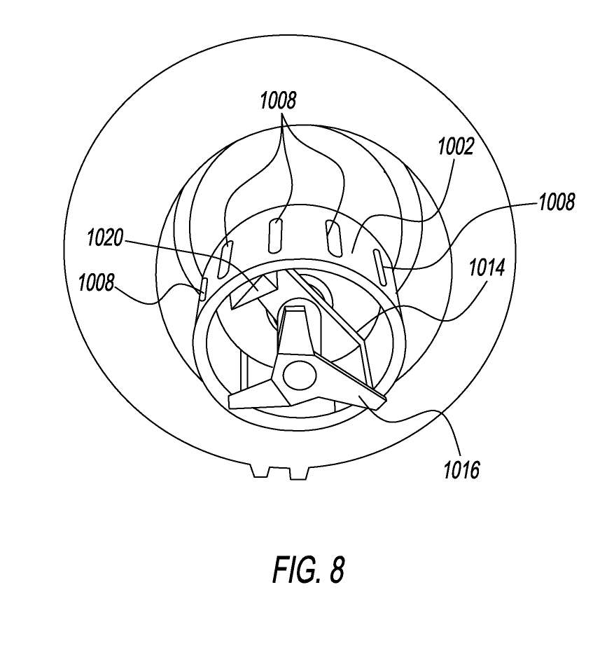

Referring to FIGS. 5-8, in operation, blender blade assembly 1000 can be used in a blend-in-cup (BiC) beverage dispenser. The BiC beverage dispenser dispenses a liquid product and ice into a cup 15. Cup 15 is then placed in a sealed blending chamber. At this point blender blade assembly 1000 is connected to a blender that is an immersion blender. Blender blade assembly 1000 is moved, for example, by linear actuator 240, downward until an attached cup seal reaches a lip of cup 15. A motor, for example, blender motor 265, is energized causing blender motor 265 to rotate inner shaft 1015 at a prescribed speed between 2000 RPM and 15000 RPM. Once blender motor 265 is energized the blender follows a programmed profile, lowering and raising blender blade assembly 1000 through cup 15 until a desired smoothie texture is reached. As the blender moves downward to a bottom of cup 15 for a first time, it is essential that blade 1016 clear a path for stator 1002. If not, ice cannot be compressed and a vertical motion of the blender is stopped. This would cause the blender to not mix ice and beverage ingredients into a smoothie. As blade 1016 clears through a mixture of ice and beverage ingredients including liquid beverage ingredients, blade 1016 also forces the mixture of the ice and beverage ingredients into the combination of rotor 1020 and stator 1002 causing high shear forces to separate product molecules, for example, product molecules of ice and flavor ingredients by rotor 1020 rotating in close proximity to stator 1002 based on an angle of leading edges 1040 of blade wings 1032. This force fed mixture is then blended rapidly into a viscous liquid. It has been found by the present disclosure that this is done more consistently and faster than any method otherwise know.

There is typically an inconsistent period of time at a beginning of blending when the ice, liquid and flavor ingredients are separated in cup 15. Once blender blade assembly 1000 begins to combine the ice, liquid and flavor ingredients, blender blade assembly 1000 is considered “primed” and the drink processing is more consistent. This inconsistent time affects the end quality of the beverage so improving a rate at which the blending system “primes” is vital to a consistent solution. Blender blade assembly 1000 includes an upper portion comprising of stator 1002 that is a fixed stator housing rigidly mounted to outer shaft 1010 and rotor 1020 that is a rotating internal rotor component that is rotationally driven a motor through inner shaft 1015 forming a rotor/stator combination. The utilization of blade 1016 which, based on the cutting edge shape or shape of leading edges 1040 and trailing edges 1042 of blade 1016, forces a multi-state product mixture up into the rotor/stator combination, minimizing the initial inconsistency and allowing the rotor/stator combination to process the beverage quickly and efficiently.

Accordingly, blender blade assembly 1000 includes an upper portion comprising of stator 1002 that is a fixed stator housing rigidly mounted to outer shaft 1010 and rotor 1020 that is a rotating internal rotor component that is rotationally driven by a motor through inner shaft 1015 forming a rotor/stator combination. Blender blade assembly 1000 includes a lower portion that is comprised of blade 1016 that is a three-winged cutting blade spaced below the rotor/stator combination and rotating on the same shaft, inner shaft 1015, as rotor 1020. Stator 1002 has some form of through holes, for example, apertures 1008, allowing mixed product to exit stator 1002. These exit channels, for example, apertures 1008, can be holes, slots or angled slots. Vanes 1024 may be flat for bludgeoning products or angled allowing cutting similar to a traditional knife blade or wedge. Rotor 1020 can have multiple vanes 1024, for example, ranging between 2 and 8 vanes. Rotor 1020 rotates in close proximity to stator 1002 causing high shear forces to separate product molecules, for example, product molecules of ice and flavor ingredients. Blade 1016 is below the rotor/stator combination. Blade 1016 utilizing leading edges 1040 that are angled leading edge cutting surfaces actually forces complicated two state mixtures into the rotor/stator combination allowing the rotor/stator to prime.

Blade 1016 includes flat center 1037 that is a flat center section and three blade wings 1032. Each of blade wings 1032 has the same overall length and same edge treatment on both a leading edge 1040 shown in FIG. 6 and trailing edges 1042 shown in FIG. 4. First wing 1034 extends perpendicular to axis of rotation A. Second wing 1036 extends at an upward angle from flat center 1037. Third wing 1038 extends at a downward angle from flat center 1037. Blender blade assembly 1000 is designed to process approximately 5-25 ounces of working medium. Alternative blades may be used. It is desirable for blade 1016 to clear a way and force a mixture of ice and beverage ingredients into a combination of rotor 1022 and stator 1002. Blade 1016 cuts into a food product mixture providing both clearance for the combination of rotor 1022 and stator 1002 to move down into the two stage food product (ice and beverage ingredients) and force the food product into the combination of rotor 1022 and stator 1002.

Blending ice, liquid and flavor ingredients (typically referred to as frozen drinks or smoothies) in cup 15 requires a certain amount of interaction between the cutting surfaces of blade 1016 and ice, liquid and flavor ingredients to achieve desired product characteristics. Blade wings 1032 has leading edges 1040 that are cutting surfaces. Vanes 1024 have apexes 1026 that are leading edges 1027a that are cutting surfaces. The design of the cutting surfaces of blade 1016, rotor 1020 and stator 1002 interaction, stator exit regions, for example, apertures 1008, blade 1016 and rotor 1020 shape, for example, paddle edge treatments (sharpness and angle of attack), length and orientation of blade wings 1032 all factor into the effectiveness of blender blade assembly 1000 at producing a desired set of product characteristics within a working medium that includes ice and beverage ingredients. A flow of an ingredient mixture of the ice, liquid and flavor ingredients in cup 15 is also critical to processing the beverage as it impacts the rate of interaction between the working medium of ice, liquid and flavor ingredients and cutting surfaces of rotor 1020 and blade 1016. Therefore a shape, number, type, orientation and relative placement of these cutting surfaces of rotor 1020 and blade 1016 to each other and the blade housing, for example, stator 1002, are critical for the processing of working medium.

Traditionally, in order to process the working medium including ice and beverage ingredients to a desired set of characteristics, a blending cycle could last between 20-40 seconds. This cycle time may be an operational burden for certain applications, typically in high use environments. Blender blade assembly 1000 improves processing times for equivalent working medium that includes ice and beverage ingredients versus traditional methods by 50% or more when an equivalent wattage motor is used to drive the system.

In addition, blender blade assembly 1000 allows blending of beverage ingredients that include vegetables and/or pieces of fruit. Blender blade assembly 1000 further allows blending of beverage ingredients that include chilled vegetables, frozen fruit, as well as flavor ingredients that include liquid flavor ingredients, for example, fruit juice and chocolate syrup, and solid ingredients, for example, nutraceuticals, vitamins, spices, herbs, berries and other fruits, vegetables, such as spinach, celery, beets, tomatoes, cucumbers, or carrots, or pieces of fruit, vegetables or candies, such as solid chocolate pieces, apple or orange segments, or cut up vegetables. Herbs such as mint, parsley, sage, rosemary, thyme, and any other herbs. Spices such as cayenne, cinnamon, curry, nutmeg and any other spices. Many challenges are encountered during a blending cycle.

### EXAMPLE

A design of blender blade assembly 1000 that produced the best results in testing included a 2 inch outside diameter stator 1002 with 12 slots, apertures 1008, each 0.125 inches in width by 0.625 inches in length evenly spaced in a circular pattern. An inner diameter of interior volume 1018 was 1.75 inches and an inner height of interior volume 1018 was 0.878 inches. Rotor 1020 utilized two wedge shaped cutting edges of vanes 1024 with leading edge 1027a in a direction of rotation. Rotor 1020 was 1.688 inch in diameter. Blade 1016 included flat center 1037 that was a flat center section and three blade wings 1032. Each of blade wings 1032 had the same overall length and same edge treatment on both leading edge 1040 shown in FIG. 6 and trailing edges 1042 shown in FIG. 4. First wing 1034 extended perpendicular to axis of rotation A. Second wing 1036 extended at an upward angle from flat center 1037. Third wing 1038 extended at a downward angle from flat center 1037. Blade 1016 was mounted below the rotor/stator combination extending at its lowest point 0.521 inches below the rotor/stator combination. Testing was performed on a 12 oz. drink, consisting of the following ingredient ratios:
40% high viscosity liquid, 41% ice, 1% water, 17% previously frozen fruit.
39% high viscosity liquid, 40% ice, 1% water, 16% previously frozen fruit, 3% chilled vegetables.
37% high viscosity liquid, 38.4% Ice, 0.6% water, 15% previously frozen fruit, 9% chilled vegetables.

For all iterations of product, the blend times were reduced between 50%-60%. Blending in half the time is a dramatic marketable difference for these products.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A blender assembly comprising:
a blender blade assembly comprising:
a rotor that is connected to a shaft, said shaft is rotatable;
a blade connected to said rotor; and
a stator that covers said rotor, said stator being stationary.

2. The blender assembly of claim 1, wherein said stator has a side wall extending from a central wall forming an interior volume.

3. The blender assembly of claim 2, wherein said shaft is an inner shaft that is in an outer shaft, and wherein said central wall of said stator is connected to said outer shaft.

4. The blender assembly of claim 2, wherein said stator has a plurality of apertures through said side wall.

5. The blender assembly of claim 4, wherein said plurality of apertures are each a stadium shape.

6. The blender assembly of claim 2, wherein said stator forms a curved surface between said side wall and said central wall.

7. The blender assembly of claim 2, wherein said side wall has a free end that is opposite an end of said side wall that forms said curved surface, and wherein said side wall has and an edge formed by a length of said side wall that decreases in width to said free end.

8. The blender assembly of claim 1, wherein said rotor has a connector that extends outward from said shaft and a vane extending from said connector.

9. The blender assembly of claim 8, wherein said connector has a rectangular shaped cross-section.

10. The blender assembly of claim 8, wherein said vane has a triangular shaped cross-section.

11. The blender assembly of claim 8, wherein said connector is two connectors that each has said vane.

12. The blender assembly of claim 11, wherein said two connectors are on opposite sides of said shaft, and wherein said two vanes have triangular shaped cross-sections that have apexes in opposite directions.

13. The blender assembly of claim 11, wherein said blade has three blade wings extending outward from said shaft.

14. The blender assembly of claim 13, wherein said three blade wings has a first wing extending perpendicular to an axis of rotation of said blade, a second wing that extends at an upward angle from a flat center of said blade, and a third wing that extends at a downward angle from the flat center.

15. The blender assembly of claim 1, wherein said shaft is connected to a motor that rotates said shaft about a vertical axis.

16. The blender assembly of claim 1, wherein said blender blade assembly allows blending of beverage ingredients from the group consisting of ice, liquid, vegetables, pieces of fruit, candies, spices, herbs, nutraceuticals, vitamins, and any combination thereof.

17. The blender assembly of claim 1, wherein said blender blade assembly allows blending of beverage ingredients from the group consisting of ice, liquid, berries, spinach, celery, beets, tomatoes, cucumbers, carrots, pieces of fruit, vegetables, candies, solid chocolate pieces, apple segments, orange segments, cut up vegetables, and any combination thereof.

18. The blender assembly of claim 1, wherein said blade is upstream of said rotor.

19. The blender assembly of claim 8, wherein said vane is perpendicular to said connector.

20. The blender assembly of claim 1, wherein said stator only covers said rotor and said blade is uncovered.
